(19) United States
(12) Patent Application Publication
(10) Pub. No.: US 2026/0050158 A1
(43) Pub. Date: Feb. 19, 2026

(54) Electronic device screen cover

(71) Applicant: Natalia Babichenko, Garden City, ID (US)

(72) Inventor: Natalia Babichenko, Garden City, ID (US)

(21) Appl. No.: 18/813,527

(22) Filed: Aug. 23, 2024

Related U.S. Application Data
(63) Continuation-in-part of application No. 29/957,706, filed on Aug. 15, 2024, now Pat. No. D1055075.

(51) Int. Cl. G02B 27/00; C08L 25/06; C08L 33/12; C08L 55/02; C08L 69/00

(52) U.S. Cl. CPC G02B 27/0081; C08L 25/06; C08L 33/12; C08L 55/02; C08L 69/00

(57) ABSTRACT

A system for protecting a display screen of an electronic device is provided. The system includes a screen protector sized to extend over the display screen of the electronic device and at least one support member configured for detachably receiving and holding the screen protector in position relative to the display screen; the support member includes a body portion having a generally rectangular shape, a receiving portion located at a proximate end of the body portion, wherein the receiving portion defines a channel configured to detachably receive and hold an edge of the screen protector.

The channel is dimensioned to snugly but releasably accommodate the thickness of the screen protector, thereby detachably securing the screen protector in a fixed position relative to the display screen.

### TECHNICAL FIELD

Embodiments disclosed herein relate generally to screen covers for electronic devices, and more specifically to detachable screen covers designed to protect the screens of electronic devices.

### BACKGROUND ART

In the field of electronic device protection, various prior art screen covers and protectors have been developed with the intention of safeguarding the screens of devices such as televisions, tablets, and smartphones. However, many of these existing solutions are plagued by significant shortcomings that diminish their effectiveness and practicality.

One of the primary issues with many prior art screen protectors is their inability to provide adequate protection against impacts, scratches, and other forms of physical damage. Many of these protectors are made from materials that are either too thin or too brittle, resulting in a limited capacity to absorb shock or resist abrasion. As a result, screens can still be damaged despite the presence of a protector, leading to costly repairs or replacements.

Moreover, many of these screen protectors are complex to install and remove, often requiring specialized tools or procedures. This complexity not only frustrates users but also increases the likelihood of improper installation, which can further compromise the protector's effectiveness. In some cases, users may inadvertently introduce air bubbles, misalign the protector, or damage the device during installation, rendering the protector ineffective.

Another significant flaw in many prior art screen covers is their tendency to degrade the viewing experience. Some protectors may introduce glare, reduce brightness, or distort colors, thereby diminishing the visual quality of the display. Others may not fit properly, leading to gaps that allow dust, moisture, or other contaminants to infiltrate and damage the screen. Furthermore, many screen protectors are not designed with modern device aesthetics in mind, resulting in a bulky or unattractive appearance that detracts from the sleek design of the electronic device.

The present invention addresses these shortcomings by providing much-needed solutions that enhance the effectiveness, ease of use, and aesthetic appeal of screen protectors. This invention offers robust protection against impacts, scratches, and other potential damage, using durable materials that are capable of absorbing shocks and resisting abrasion. Unlike many prior art protectors, this invention maintains the visual clarity and touch sensitivity of the device's screen, ensuring an optimal user experience.

In addition to its protective capabilities, the present invention simplifies the installation and removal process. It is designed to be user-friendly, eliminating the need for specialized tools or complex procedures. This reduces the risk of improper installation and ensures that the protector fits securely without compromising the device's appearance or functionality.

Furthermore, the present invention is thoughtfully designed to complement the modern, streamlined aesthetics of electronic devices. It offers a sleek and unobtrusive appearance that blends seamlessly with the device, while also providing the necessary protection. This versatility allows the protector to be used with a wide range of devices without sacrificing style or performance.

In conclusion, while prior art screen protectors have struggled to meet the needs of users, the present invention provides effective, user-friendly, and aesthetically pleasing solutions that significantly improve the protection and usability of electronic devices. This invention represents a substantial advancement in the field of screen protection, offering users the reliable defense their devices require without compromising on quality or appearance.

### SUMMARY OF THE EMBODIMENTS

A system for protecting a display screen of an electronic device is provided. The system includes a screen protector sized to extend over the display screen of the electronic device, at least one support member configured for detachably receiving and holding the screen protector in position relative to the display screen; the support member includes a body portion having a generally rectangular shape, a receiving portion located at a proximate end of the body portion, wherein the receiving portion defines a channel configured to detachably receive and hold an edge of the screen protector. The channel is dimensioned to snugly but releasably accommodate the thickness of the screen protector, thereby detachably securing the screen protector in a fixed position relative to the display screen.

In accordance with some embodiments of the present invention, the system can also include an adhesive pad attached to a bottom side of the support member, wherein the adhesive pad is configured to attach the support member to at least one of a top edge or a side edge of the display screen.

In some instances, the system can include a first Velcro pad attached to a bottom side of the support member, wherein the first Velcro pad is configured to detachably engage with a corresponding second Velcro pad attached to at least one of a top edge or a side edge of the display screen, thereby securing the support member to the display screen.

Other aspects, embodiments and features of the device and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the device and method shown where illustration is not necessary to allow those of ordinary skill in the art to understand the device and method.

### BRIEF DESCRIPTION OF THE DRAWINGS

The preceding summary, as well as the following detailed description of the disclosed device and method, will be better understood when read in conjunction with the attached drawings. It should be understood, however, that neither the device nor the method is limited to the precise arrangements and instrumentalities shown.

FIG. 1 is a perspective view of an electronic device screen cover mounted on a TV, in accordance with an embodiment of the present invention.

FIG. 2 is a front perspective view of the electronic device screen cover without the TV.

FIG. 3 is a back perspective view of the electronic device screen cover.

FIG. 4 is a front view of the electronic device screen cover.

FIG. 5 is a back view of the electronic device screen cover.

FIG. 6 is a left-side view of the electronic device screen cover.

FIG. 7 is a right-side view of the electronic device screen cover.

FIG. 8 is a top view of the electronic device screen cover.

FIG. 9 is a bottom view of the electronic device screen cover.

FIG. 10 is a back view of the electronic device screen cover.

FIG. 11 is a zoom view of the electronic device screen cover of FIG. 10 showing a Velcro attachment.

FIG. 12 is a perspective view of the electronic device screen cover of FIG. 1 showing an adhesive pad.

FIG. 13 is a zoom view of the electronic device screen cover of FIG. 12.

FIG. 14 is a perspective view of the support member.

FIG. 15 is a front cross-sectional view of the support member shown in FIG. 14.

FIG. 16 is a perspective view of the support member with a cushioning pad.

FIG. 17 is a front cross-sectional view of the support member shown in FIG. 16.

### DETAILED DESCRIPTION OF SPECIFIC EMBODIMENTS

A person skilled in the art will recognize that the devices and methods disclosed herein can be adapted for use with a wide range of electronic devices. These include, but are not limited to, televisions, computers, and mobile devices such as smartphones, tablets, e-readers, personal digital assistants (PDAs), and similar devices.

The present invention provides a system for protecting a display screen of an electronic device, which provides an effective, user-friendly, and aesthetically pleasing solution that significantly improves the protection and usability of electronic devices.

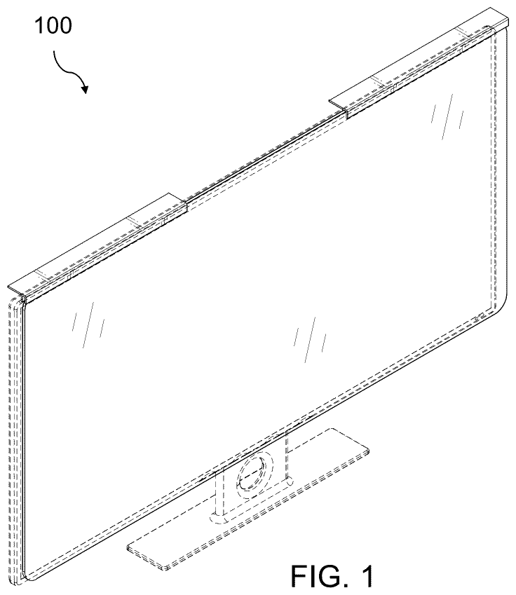

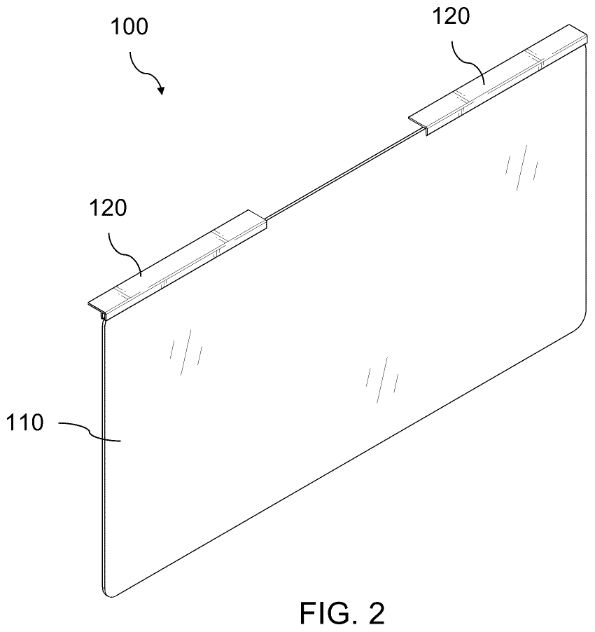

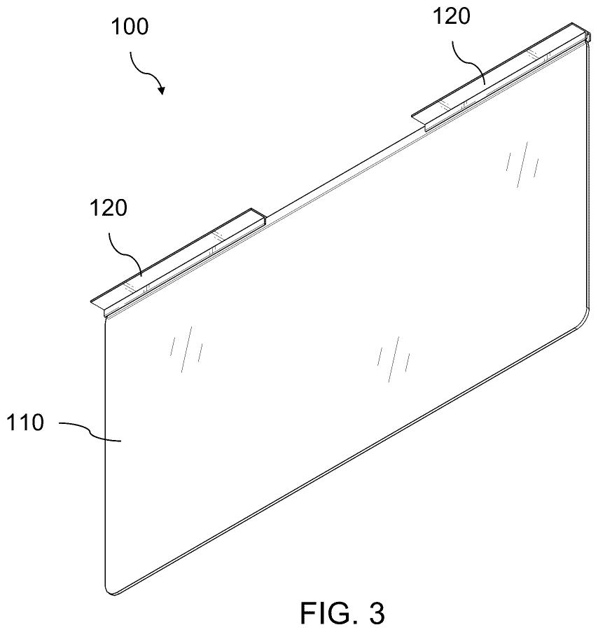

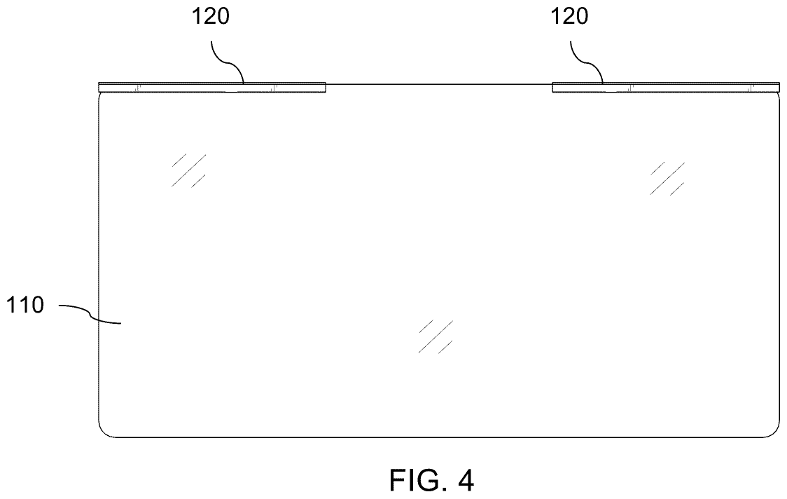

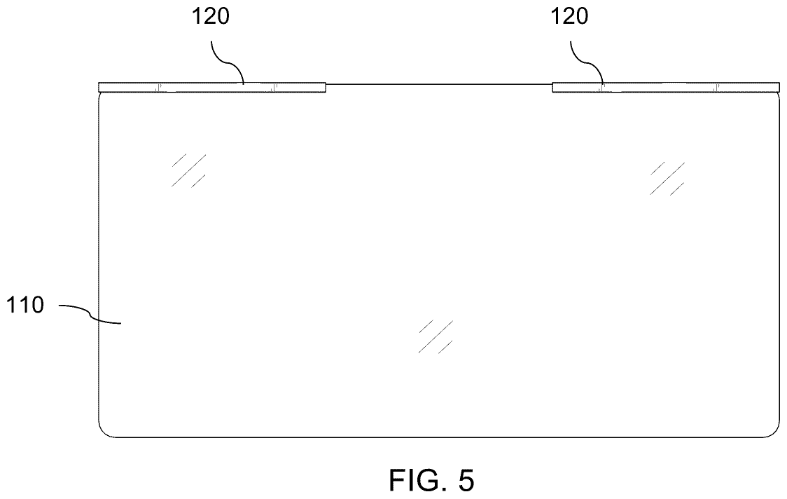

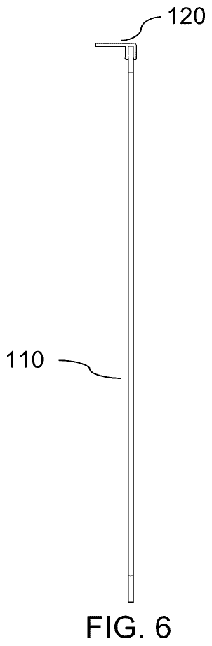

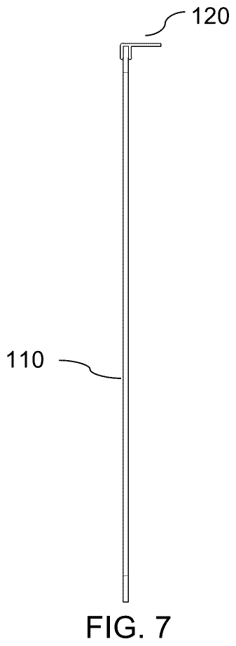

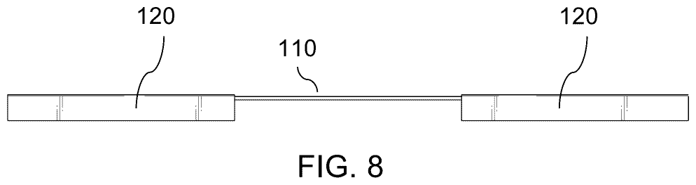

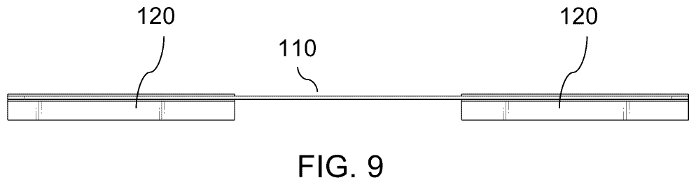

FIG. 1 shows a perspective view of system 100 for protecting a display screen of an electronic device. As further illustrated in FIGS. 2-9, the system 100 includes a screen protector 110 sized to extend over the display screen of the electronic device and at least one support member 120 configured for detachably receiving and holding the screen protector 110 in position relative to the display screen.

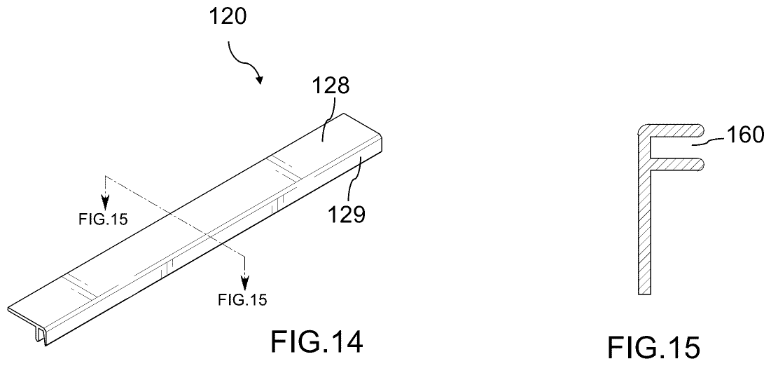

As shown in FIGS. 14-15, the support member 120 includes a body portion 128 having a generally rectangular shape, a receiving portion 129 located at a proximate end of the body portion 128, wherein the receiving portion 129 defines a channel 160 configured to detachably receive and hold an edge of the screen protector. The channel 160 is dimensioned to snugly but releasably accommodate the thickness of the screen protector, thereby detachably securing the screen protector in a fixed position relative to the display screen.

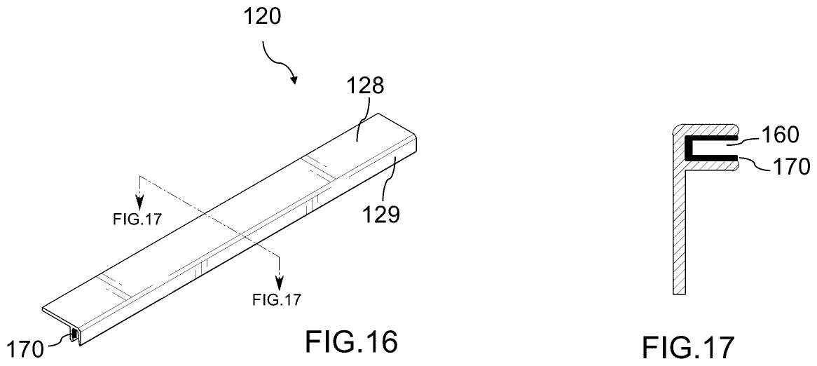

According to some embodiments of the present invention, as further illustrated in FIGS. 16-17, the support member 120 further includes a cushioning layer 170 on the inner surface of the channel 160; the cushioning layer 170 is configured to protect the edges of the screen protector 110 from damage when inserted into the channel 160. The channel 160 can be a U-shaped channel, or can have other similar shapes such as C-shaped channel, which has a more circular or semi-circular profile, or Horseshoe-shaped channel with more rounded or elongated sides, resembling a horseshoe; or Semi-circular channel, which is a half-circle shape having a smoother, more rounded curve; or a Trapezoidal channel having a wider tip and narrow bottom, having straight, angled sides; or an Open Rectangular channel, a shape that is rectangular with one side open; or Omega-shaped channel with curved ends that turn inward, resembling the Greek letter Omega.

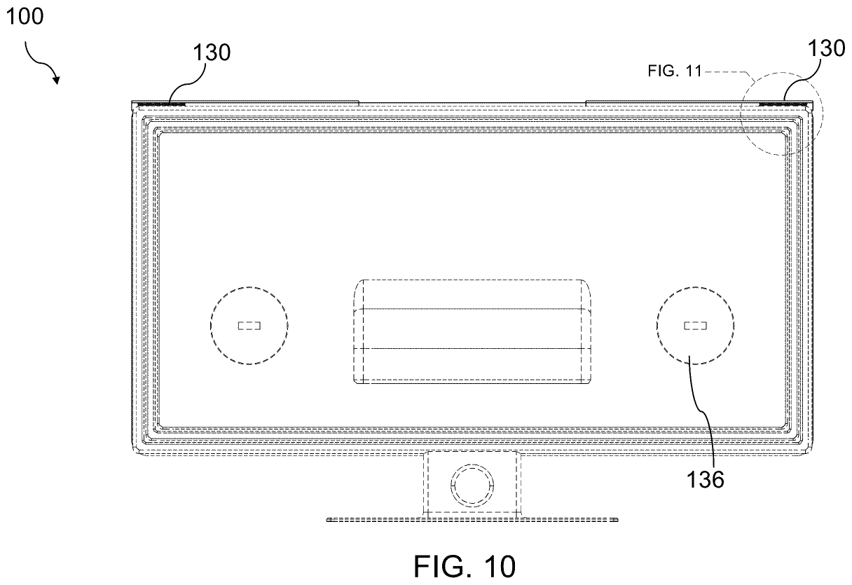

In some instances, the support member 120 can include one or more adhesive pads 130 attached to a bottom side of the support member 120, wherein the adhesive pad 130 is configured to attach the support member 120 to at least one of a top edge or a side edge of the display screen of the electronic device, as shown in FIGS. 10-11, for example.

According to some embodiments of the present invention, the pad 130 can be a first Velcro pad attached to a bottom side of the support member 120, wherein the first Velcro pad 130 is configured to detachably engage with a corresponding second Velcro pad attached to at least one of a top edge or a side edge of the display screen, thereby securing the support member to the display screen. The first and second Velcro pads are made of a combination of acrylonitrile butadiene styrene (ABS) and polystyrene (PS), providing enhanced strength and durability for the attachment mechanism.

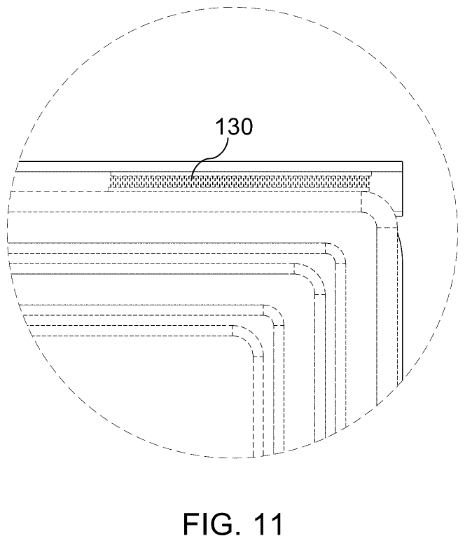

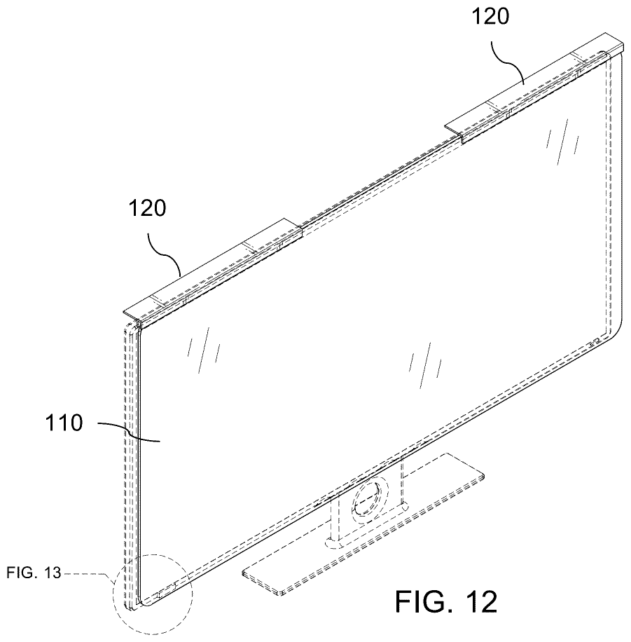

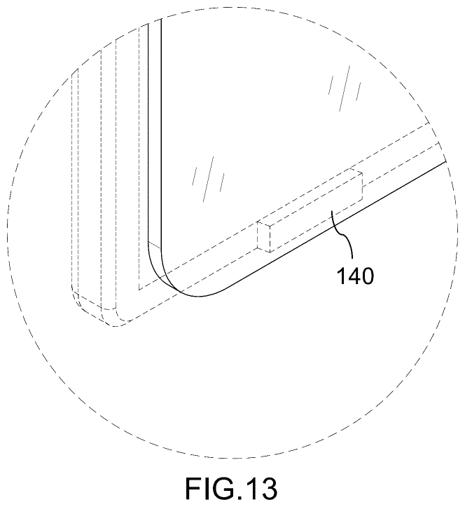

In some instances, as shown in FIGS. 12-13, the screen protector 110 includes one or more adhesive pads 140 attached to its bottom edge. These adhesive pads 140 are designed to be either attached to or pressed against the frame of the display screen. This configuration helps prevent the screen protector from moving, shaking, or otherwise shifting during use, thereby ensuring it remains securely in place.

The screen protector can be made of a combination of polymethyl methacrylate (PMMA) and polycarbonate (PC), providing enhanced durability and optical clarity. The screen protector can also include indicia on at least one surface; the indicia is configured to provide visual information or decorative elements.

In some instances, the screen protector can also include an anti-glare coating on at least one surface, the coating being configured to reduce reflections and improve visibility of the display screen under various lighting conditions. The screen protector can include an anti-scratch layer on at least one surface, the layer being configured to protect the screen protector from scratches and abrasions during use.

According to some embodiments of the present invention, the screen protector includes a UV-resistant coating, the coating being configured to block ultraviolet (UV) radiation to prevent degradation and yellowing of the screen protector over time.

In some instances, the support member can be hingedly connected to the frame of the electronic device by way of a hinge mechanism; the hinge mechanism is configured to allow the screen protector to be pivoted away from the display screen without fully detaching the support member.

As shown in FIG. 10, the screen protector can further include one or more cutouts 136 aligned with sensors or cameras on the display screen; the cutouts 136 are configured to allow unobstructed operation of the sensors or cameras.

The support member can include adjustable clamps, the clamps being configured to allow the support member to be secured at various positions along the edges of the display screen.

The screen protector can include a privacy filter layer, which is configured to limit the viewing angle of the display screen to prevent unauthorized viewing from the sides. The privacy filter layer is constructed from advanced micro-louver technology, which consists of multiple layers of thin, flexible materials, such as polyvinyl alcohol (PVA) or polyethylene terephthalate (PET), arranged in a specific pattern. These materials are chosen for their optical clarity and durability, allowing the screen protector to maintain high-quality visual output for the primary user while effectively blocking side views.

The micro-louvers are embedded between transparent polymer films, typically coated with an anti-glare or anti-reflective coating to further enhance the viewing experience under various lighting conditions. The outer layers of the privacy filter may also include a hard-coating made from materials like polyurethane (PU) to resist scratches and smudges, thereby preserving the filter's effectiveness and longevity.

Additionally, the privacy filter layer is designed to be thin and lightweight, ensuring that it does not significantly add to the thickness of the screen protector or compromise the touch sensitivity of the display screen. The combination of these materials ensures that the privacy filter provides robust privacy protection while maintaining the overall functionality and aesthetics of the electronic device.

The support member can be formed from a transparent or translucent material, allowing it to blend aesthetically with the surrounding environment of the display screen.

The support member can be made from a variety of materials depending on the desired properties such as strength, flexibility, weight, and cost. Acrylonitrile Butadiene Styrene (ABS) is a strong, durable, and impact-resistant material commonly used in consumer electronics and automotive parts. Polycarbonate (PC) offers high-impact resistance, is transparent, and lightweight, making it ideal for use in protective gear and eyewear. Polymethyl Methacrylate (PMMA) is a lightweight, shatter-resistant material that provides good optical clarity and is frequently used in windows, skylights, and light covers.

Polyethylene (PE) is another option, known for being lightweight, flexible, and resistant to chemicals and moisture, making it suitable for various types of packaging and containers. Polypropylene (PP) is tough, fatigue-resistant, and flexible, often used in automotive components and textiles. Aluminum, known for being lightweight, strong, and corrosion-resistant, is commonly employed in structural components and aerospace applications.

Nylon (Polyamide) is a strong, wear-resistant material with good elasticity, frequently utilized in mechanical components and textiles. Polyvinyl Chloride (PVC) is durable and resistant to chemicals and moisture, making it a popular choice in construction and electrical insulation. Fiberglass Reinforced Plastic (FRP) offers strength, light weight, and resistance to corrosion, and is used in construction, automotive, and marine industries.

According to some embodiments of the present invention, the screen protector can also include a protective film covering at least one surface of the screen protector, which is configured to be peeled off before use to expose the underlying surface of the screen protector. The protective film can be made using variety of materials that are transparent, durable, easy to peel off, and provide adequate protection during storage and handling. The following are the top choices for those type of materials in accordance with the embodiments of the present invention.

Polyethylene Terephthalate (PET): PET is a highly transparent and durable material commonly used in protective films. It is resistant to scratches and provides excellent clarity, ensuring that the underlying surface of the screen protector remains visible and intact until the film is peeled off. PET films are also easy to handle and peel, making them an ideal choice for temporary protective coverings. Polyvinyl Chloride (PVC): PVC is another popular material for protective films due to its durability and flexibility. It offers good protection against dust, scratches, and minor impacts. PVC films are easy to apply and remove, making them suitable for covering surfaces that need to be protected during shipping or before installation. Polypropylene (PP): Polypropylene is a lightweight and flexible material that is resistant to moisture and chemicals. It is commonly used in protective films because it can be easily peeled off without leaving residue on the underlying surface. PP films provide a good balance between protection and ease of use. Polyethylene (PE): PE is a softer material compared to PET and PVC, which makes it particularly effective at protecting against dust and minor abrasions. PE films are often used as protective layers that are meant to be removed before the final use of a product. They are also cost-effective and easy to remove. Thermoplastic Polyurethane (TPU): TPU is a flexible and durable material that offers excellent protection against scratches and impacts. It is commonly used in high-end protective films where a higher degree of protection is required. TPU films can be easily peeled off, making them a good choice for applications where the protective film needs to be removed without damaging the underlying surface. Acrylic (PMMA) Coated Films: Acrylic-coated films provide enhanced optical clarity and are highly resistant to scratches and chemical exposure. These films are often used in applications where maintaining the visual quality of the screen protector is critical. The acrylic layer can be easily peeled off, leaving the screen protector in perfect condition.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The foregoing detailed description is merely exemplary in nature and is not intended to limit the invention or application and uses of the invention. Furthermore, there is no intention to be bound by any expressed or implied theory presented in the preceding technical field, background, brief summary, or the following detailed description.

1. A system for protecting a display screen of an electronic device, comprising:
a screen protector sized to extend over the display screen of the electronic device; and
a pair of support members spaced apart from each other and configured for detachably receiving and holding the screen protector in position relative to the display screen, each support member comprising:
a body portion having a generally rectangular shape;
a receiving portion located exclusively at a proximate end of the body portion, wherein the receiving portion defines a U-shaped channel configured to detachably receive and hold an edge of the screen protector, the end-based placement providing a defined orientation and alignment of the screen protector relative to the display screen; and
an attachment pad affixed to a bottom side of the support member, the attachment pad being configured to attach each support member to at least one of a top edge or a side edge of the display screen; and
a cushioning layer lining an inner surface of the U-shaped channel, the cushioning layer being fixed relative to the support member and configured to protect the edges of the screen protector from damage during insertion and removal;
wherein the screen protector is held in a non-contacting, spaced relation above the display screen by the support members, such that the screen protector is supported solely at its edges and remains free of direct contact with the front surface of the display screen.

2. The system of claim 1, wherein the attachment pad comprises an adhesive pad attached to a bottom side of the support member, the adhesive pad being configured to attach the support member to at least one of a top edge or a side edge of the display screen.

3. The system of claim 1, wherein the attachment pad comprises a first Velcro pad attached to a bottom side of the support member, the first Velcro pad being configured to detachably engage with a corresponding second Velcro pad attached to at least one of a top edge or a side edge of the display screen.

4. The system of claim 1, wherein the screen protector is made of a combination of polymethyl methacrylate (PMMA) and polycarbonate (PC), providing enhanced durability and optical clarity.

5. The system of claim 3, wherein the first and second Velcro pads are made of a combination of acrylonitrile butadiene styrene (ABS) and polystyrene (PS), providing enhanced strength and durability for the attachment mechanism.

6. The system of claim 1, wherein the screen protector further comprises indicia on at least one surface, the indicia being configured to provide visual information or decorative elements.

7. The system of claim 1, wherein the screen protector further comprises an anti-glare coating on at least one surface, the coating being configured to reduce reflections and improve visibility of the display screen under various lighting conditions.

8. The system of claim 1, wherein the screen protector further comprises an anti-scratch layer on at least one surface, the layer being configured to protect the screen protector from scratches and abrasions during use.

9. The system of claim 1, wherein the screen protector further comprises a UV-resistant coating, the coating being configured to block ultraviolet (UV) radiation to prevent degradation and yellowing of the screen protector over time.

10. The system of claim 1, wherein the support member further comprises a hinge mechanism, the hinge mechanism being configured to allow the screen protector to be pivoted away from the display screen without fully detaching the support member.

11. The system of claim 1, wherein the support member further comprises a cushioning layer on the inner surface of the channel, the cushioning layer being configured to protect the edges of the screen protector from damage when inserted into the channel.

12. The system of claim 1, wherein the screen protector further comprises one or more cutouts aligned with sensors or cameras on the display screen, the cutouts being configured to allow unobstructed operation of the sensors or cameras.

13. The system of claim 1, wherein the support member further comprises adjustable clamps, the clamps being configured to allow the support member to be secured at various positions along the edges of the display screen.

14. The system of claim 1, wherein the screen protector further comprises a privacy filter layer, the layer being configured to limit the viewing angle of the display screen to prevent unauthorized viewing from the sides.

15. The system of claim 1, wherein the support member is formed from a transparent or translucent material, allowing it to blend aesthetically with the surrounding environment of the display screen.

16. (canceled)

17. The system of claim 1, wherein the screen protector further comprises a protective film covering at least one surface of the screen protector, the protective film being configured to be peeled off before use to expose the underlying surface of the screen protector.

18. The system of claim 1, wherein the screen protector further comprises one or more adhesive pads attached to a bottom edge of the screen protector, the adhesive pads being configured to attach to a frame of the display screen to prevent the screen protector from moving, shaking, or otherwise shifting during use.

19. (canceled)

20. A system for protecting a display screen of an electronic device, comprising:
a screen protector sized to extend over the display screen of the electronic device; and
a pair of support members spaced apart from each other and configured for detachably receiving and holding the screen protector in position relative to the display screen, the support member comprising:
a body portion having a generally rectangular shape;
a receiving portion located exclusively at a proximate end of the body portion, wherein the receiving portion defines a U-shaped channel configured to detachably receive and hold an edge of the screen protector, the end-based placement providing a defined orientation and alignment of the screen protector relative to the display screen; and
an attachment pad affixed to a bottom side of the support member, the attachment pad being configured to attach each support member to at least one of a top edge or a side edge of the display screen;
wherein each support member is formed as a non-integrated, repositionable module and is not structurally integrated into a housing or enclosure of the electronic device;
wherein each support member is formed from a transparent or translucent polycarbonate or polymethyl methacrylate (PMMA) material, the material being selected for both optical clarity and structural rigidity;
wherein the support member construction is configured to aesthetically blend with the exterior of the electronic device and enable visible alignment during attachment; and
wherein each support member further comprises integrated adjustable clamps configured to permit repeatable repositioning of the support member along the perimeter of the display screen without requiring modification of the electronic device housing.
